(19) United States
(12) Patent Application Publication
(10) Pub. No.: US 2024/0199899 A1
(43) Pub. Date: Jun. 20, 2024

(54) NEUTRALIZED MULTI-AMINE DISPERSANT COMPOSITIONS

(71) Applicant: Lubrizol Advanced Materials, Inc., Cleveland, OH (US)

(72) Inventors: Conor Wilkinson, Prestwich (GB); Elliot Coulbeck, Bury (GB); Sergio Escuriet, Cabrils (Barcelona) (ES); Michael Collinge, Blackley (GB)

(21) Appl. No.: 18/285,873

(22) PCT Filed: Apr. 7, 2022
(86) PCT No.: PCT/US2022/023862

§ 371 Date: Oct. 6, 2023

Related U.S. Application Data
(60) Provisional application No. 63/172,890, filed on Apr. 9, 2021.

(51) Int. Cl. C09D 11/037; C08G 65/334; C09D 11/14; C09D 17/00

(52) U.S. Cl. CPC C09D 11/037; C08G 65/3346; C09D 11/14; C09D 17/003

(57) ABSTRACT

Described are compositions including: (a) a polymeric dispersant including: (i) an average of at least two polyether pendant groups per molecule; and (ii) an average of at least two amine groups per molecule; and (b) a functionalized acid component including sulfonic acid and/or phosphoric acid functionalized with at least one of an aromatic functional group or a fatty functional group; and wherein at least about 60 percent of the amine groups present in the polymeric dispersant are each individually neutralized with a molecule of the functionalized acid component. Also described are pigment dispersions and/or ink formulations including these compositions, as well as various methods of making and/or using the compositions, pigment dispersions, and/or ink formulations.

The disclosed technology relates to compositions including polymeric dispersants having an average of at least two amine groups per molecule, at least partially neutralized (e.g., salted) with a functionalized acid component. Pigment dispersions and ink formulations including these compositions are also described, as well as methods of making and/or using these materials.

Many conventional packaging inks are manufactured around a generic formulation of pigment, binder, adhesion promoter, and solvent. Illustrative ink formulations are described, for example, in JP 2017-39896 A. In many cases, the binder acts as a dispersing aid and prevents re-agglomeration of the pigment particles following milling. However, in other cases, the use of a bespoke dispersant improves the ink properties significantly, such as stability, pigment content and color development. Generally, polymeric dispersants may be acid-functional, amine-functional, or non-ionic. However, non-ionic or acid-based dispersants have been used in this application, due to compatibility problems that may occur when using amine-functional dispersants with other ingredients in the formulation.

A significant pigment used in packaging inks is the pigment Yellow 13. It has been observed that to disperse Yellow 13 using a polymeric dispersant, the functionality of the dispersant is strongly preferred to include amine groups, to provide sufficient anchoring of the dispersant to the pigment's surface. One binder used in packaging inks is nitrocellulose, as seen, for example, in JP 2018-199802 A; it has been found that amine-functional dispersants interact unfavorably with this binder, leading to gel formation over time, which would be catastrophic for a fully-formulated ink composition. Similarly, organometallic complexes, such as titanate, have a long history in the formulation of packaging inks, as seen, for example, in WO 2012/028882 A1, to provide adhesion to low-surface-energy substrates, such as polyethylene or oriented polypropylene, when used in combination with a binder. However, the organometallic complexes are highly vulnerable to unwanted reaction with amine-functional dispersants, again forming gels and/or increasing viscosity.

Polymeric dispersants having a plurality of amine groups are described, for example, in the following documents: U.S. Pat. Nos. 7,767,750 B2, 8,859,675 B2, 8,987,374 B2, and 9,416,280 B2. These documents do not disclose polymeric dispersants having an average of at least two amine groups per molecule, wherein at least about 60 percent of the amine groups present in the polymeric dispersant are each individually neutralized (e.g., salted) with a molecule of a functionalized acid component.

The disclosed technology, therefore, provides compositions comprising polymeric dispersants having an average of at least two amine groups per molecule, wherein at least about 60 percent of the amine groups present in the polymeric dispersant are each individually neutralized with a molecule of a functionalized acid component, as described herein. It has been found that these compositions may at least partially mitigate the problematic interactions an amine-functional dispersant may have with other ingredients, by forming an amine salt using a sulfonic or phosphoric counter-ion, resulting in suitable performance with certain ingredients, such as additives (e.g., organometallic complexes) and/or binders (e.g., nitrocellulose).

The subject matter disclosed herein provides compositions comprising: (a) a polymeric dispersant comprising: (i) an average of at least two polyether pendant groups per molecule, wherein the at least two polyether pendant groups are made up of monomeric units, wherein at least half of the monomeric units are poly(ethylene oxide) monomeric units and/or poly(propylene oxide) monomeric units, and wherein the at least two polyether pendant groups make up at least 50 weight percent of the polymeric dispersant, based on the total weight of the polymeric dispersant; and (ii) an average of at least two amine groups per molecule, wherein the at least two amine groups are not present in the at least two polyether pendant groups; and (b) a functionalized acid component comprising sulfonic acid and/or phosphoric acid functionalized with at least one of an aromatic functional group or a fatty functional group; and wherein at least about 60 percent of the amine groups present in the polymeric dispersant are each individually neutralized with a molecule of the functionalized acid component.

Also provided are pigment dispersions comprising: (a) a pigment; (b) a polymeric dispersant for the pigment comprising: (i) an average of at least two polyether pendant groups per molecule, wherein the at least two polyether pendant groups are made up of monomeric units, wherein at least half of the monomeric units are poly(ethylene oxide) monomeric units and/or poly(propylene oxide) monomeric units, and wherein the at least two polyether pendant groups make up at least 50 weight percent of the polymeric dispersant, based on the total weight of the polymeric dispersant; and (ii) an average of at least two amine groups per molecule, wherein the at least two amine groups are not present in the at least two polyether pendant groups; and (c) a functionalized acid component comprising sulfonic acid and/or phosphoric acid functionalized with at least one of an aromatic functional group or a fatty functional group; and wherein at least about 60 percent of the amine groups present in the polymeric dispersant are each individually neutralized with a molecule of the functionalized acid component.

Also provided are ink formulations comprising: (a) the pigment dispersion(s) described herein; (b) a solvent; (c) a binder; and (d) at least one additional additive.

Also provided are methods of producing pigment dispersions comprising a step of combining, in any order, a pigment, a polymeric dispersant for the pigment, and a functionalized acid component, and an optional step of milling the pigment, wherein: (a) the polymeric dispersant comprises: (i) an average of at least two polyether pendant groups per molecule, wherein the at least two polyether pendant groups are made up of monomeric units, wherein at least half of the monomeric units are poly(ethylene oxide) monomeric units and/or poly(propylene oxide) monomeric units, and wherein the at least two polyether pendant groups make up at least 50 weight percent of the polymeric dispersant, based on the total weight of the polymeric dispersant; (ii) and an average of at least two amine groups per molecule, wherein the at least two amine groups are not present in the at least two polyether pendant groups; (b) the functionalized acid component comprises sulfonic acid and/or phosphoric acid functionalized with at least one of an aromatic functional group or a fatty functional group; (c) at least about 60 percent of the amine groups present in the polymeric dispersant are each individually neutralized with a molecule of the functionalized acid component; and (d) the optional step of milling the pigment: (i) is not performed; (ii) is performed on the pigment alone prior to addition of the polymeric dispersant and/or the functionalized acid component; or (iii) is performed on a combination of the pigment and the polymeric dispersant and/or the functionalized acid component.

Also provided are methods of manufacturing ink formulation comprising, in order: (a) performing the method(s) of forming pigment dispersion(s) described herein; and (b) adding the following ingredients to the pigment dispersion: (i) a solvent; (ii) a binder; and (iii) at least one additional additive.

### THE FOLLOWING EMBODIMENTS OF THE PRESENT SUBJECT MATTER ARE CONTEMPLATED

1. A composition comprising: (a) a polymeric dispersant comprising: (i) an average of at least two polyether pendant groups per molecule, wherein the at least two polyether pendant groups are made up of monomeric units, wherein at least half of the monomeric units are poly(ethylene oxide) monomeric units and/or poly(propylene oxide) monomeric units, and wherein the at least two polyether pendant groups make up at least 50 weight percent of the polymeric dispersant, based on the total weight of the polymeric dispersant; and (ii) an average of at least two amine groups per molecule, wherein the at least two amine groups are not present in the at least two polyether pendant groups; and (b) a functionalized acid component comprising sulfonic acid and/or phosphoric acid functionalized with at least one of an aromatic functional group or a fatty functional group; and wherein at least 60 percent of the amine groups present in the polymeric dispersant are each individually neutralized with a molecule of the functionalized acid component.
2. The composition of embodiment 1, wherein the polymeric dispersant comprises an average of from 2 to 200 polyether pendant groups per molecule.
3. The composition of either embodiment 1 or embodiment 2, wherein from 50% to substantially all of the monomeric units of the polyether pendant groups are poly(ethylene oxide) monomeric units and/or poly(propylene oxide) monomeric units.
4. The composition of any one of embodiments 1 to 3, wherein the ratio of the number of poly(ethylene oxide) monomeric units to the number of poly(propylene oxide) monomeric units is from 0:100 to 90:10.
5. The composition of any one of embodiments 1 to 4, wherein the polyether pendant groups make up at least 65 weight percent of the polymeric dispersant, based on the total weight of the polymeric dispersant.
6. The composition of any one of embodiments 1 to 5, wherein the polymeric dispersant comprises an average of from 2 to 500 amine groups per molecule.
7. The composition of any one of embodiments 1 to 6, wherein the functionalized acid component comprises sulfonic acid functionalized with at least one of an aromatic functional group or a fatty functional group.
8. The composition of any one of embodiments 1 to 7, wherein the functionalized acid component comprises dodecyl benzene sulfonic acid.
9. The composition of any one of embodiments 1 to 8, wherein the aromatic functional group is an optionally substituted C₆-C₁₀ aromatic group.
10. The composition of any one of embodiments 1 to 9, wherein the fatty functional group is a linear or branched, saturated or unsaturated, C₈-C₂₂ hydrocarbon group.
11. The composition of any one of embodiments 1 to 6, wherein the functionalized acid component comprises at least one compound according to the following general formula:

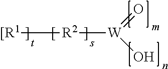

wherein: R¹ is a linear or branched, saturated or unsaturated, C₈-C₂₂ hydrocarbon group; R² is an aromatic functional group, optionally a substituted C₆-C₁₀ aromatic group; W is phosphorus or sulfur; m is 1 or 2, wherein m is 1 or 2 when W is sulfur, and m is 1 when W is phosphorus; n is 1 or 2, wherein n is 1 when W is sulfur, and n is 2 when W is phosphorus; s is 0 or 1; t is 0 or 1; with the proviso that s and t cannot both be 0.
12. The composition of embodiment 11, wherein W is sulfur.
13. The composition of either embodiment 11 or embodiment 12, wherein s is 1 and tis 1.
14. The composition of any one of embodiments 1 to 13, wherein at least about 75 percent of the amine groups present in the polymeric dispersant are each individually neutralized with a molecule of the functionalized acid component.
15. The composition of any one of embodiments 1 to 14, wherein at least about 95 percent of the amine groups present in the polymeric dispersant are each individually neutralized with a molecule of the functionalized acid component.
16. A pigment dispersion comprising: (a) a pigment; (b) a polymeric dispersant for the pigment comprising: (i) an average of at least two polyether pendant groups per molecule, wherein the at least two polyether pendant groups are made up of monomeric units, wherein at least half of the monomeric units are poly(ethylene oxide) monomeric units and/or poly(propylene oxide) monomeric units, and wherein the at least two polyether pendant groups make up at least 50 weight percent of the polymeric dispersant, based on the total weight of the polymeric dispersant; and (ii) an average of at least two amine groups per molecule, wherein the at least two amine groups are not present in the at least two polyether pendant groups; and (b) a functionalized acid component comprising sulfonic acid and/or phosphoric acid functionalized with at least one of an aromatic functional group or a fatty functional group; and wherein at least 60 percent of the amine groups present in the polymeric dispersant are each individually neutralized with a molecule of the functionalized acid component.
17. The pigment dispersion of embodiment 16, wherein the polymeric dispersant comprises an average of from 2 to 200 polyether pendant groups per molecule.
18. The pigment dispersion of either embodiment 16 or embodiment 17, wherein from 50% to substantially all of the monomeric units of the polyether pendant groups are poly(ethylene oxide) monomeric units and/or poly(propylene oxide) monomeric units.
19. The pigment dispersion of any one of embodiments 16 to 18, wherein the ratio of the number of poly(ethylene oxide) monomeric units to the number of poly(propylene oxide) monomeric units is from 0:100 to 90:10.
20. The pigment dispersion of any one of embodiments 16 to 19, wherein the polyether pendant groups make up at least 65 weight percent of the polymeric dispersant, based on the total weight of the polymeric dispersant.
21. The pigment dispersion of any one of embodiments 16 to 20, wherein the polymeric dispersant comprises an average of from 2 to 500 amine groups per molecule.
22. The pigment dispersion of any one of embodiments 16 to 21, wherein the functionalized acid component comprises sulfonic acid functionalized with at least one of an aromatic functional group or a fatty functional group.
23. The pigment dispersion of any one of embodiments 16 to 22, wherein the functionalized acid component comprises dodecyl benzene sulfonic acid.
24. The pigment dispersion of any one of embodiments 16 to 23, wherein the aromatic functional group is an optionally substituted C₆-C₁₀ aromatic group.
25. The pigment dispersion of any one of embodiments 16 to 24, wherein the fatty functional group is a linear or branched, saturated or unsaturated, C₈-C₂₂ hydrocarbon group.
26. The pigment dispersion of any one of embodiments 16 to 25, wherein the functionalized acid component comprises at least one compound according to the following general formula:

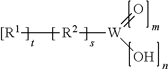

wherein: R¹ is a linear or branched, saturated or unsaturated, C₈-C₂₂ hydrocarbon group; R² is an aromatic functional group, optionally a substituted C₆-C₁₀ aromatic group; W is phosphorus or sulfur; m is 1 or 2, wherein m is 1 or 2 when W is sulfur, and m is 1 when W is phosphorus; n is 1 or 2, wherein n is 1 when W is sulfur, and n is 2 when W is phosphorus; s is 0 or 1; t is 0 or 1; with the proviso that s and t cannot both be 0.
27. The pigment dispersion of embodiment 26, wherein W is sulfur.
28. The pigment dispersion of either embodiment 26 or embodiment 27, wherein sis 1 and tis 1.
29. The pigment dispersion of any one of embodiments 16 to 28, wherein at least about 75 percent of the amine groups present in the polymeric dispersant are each individually neutralized with a molecule of the functionalized acid component.
30. The pigment dispersion of any one of embodiments 16 to 29, wherein at least about 95 percent of the amine groups present in the polymeric dispersant are each individually neutralized with a molecule of the functionalized acid component.
31. An ink formulation comprising: (a) the pigment dispersion of any one of embodiments 16 to 30; (b) a solvent; (c) a binder; and (d) at least one additional additive.
32. The ink formulation of embodiment 31, wherein the solvent is a polar solvent.
33. The ink formulation of either embodiment 31 or embodiment 32, wherein the binder is a polymeric binder.
34. The ink formulation of any one of embodiments 31 to 33, wherein the at least one additional additive comprises from 1 to 5 additional additives.
35. The ink formulation of any one of embodiments 31 to 34, wherein the at least one additional additive comprises at least one of a wetting agent, a stabilizing agent, an adhesion promoter, a wax, or a defoamer.
36. A method of producing a pigment dispersion comprising a step of combining, in any order, a pigment, a polymeric dispersant for the pigment, and a functionalized acid component, and an optional step of milling the pigment, wherein: (a) the polymeric dispersant comprises: (i) an average of at least two polyether pendant groups per molecule, wherein the at least two polyether pendant groups are made up of monomeric units, wherein at least half of the monomeric units are poly(ethylene oxide) monomeric units and/or poly(propylene oxide) monomeric units, and wherein the at least two polyether pendant groups make up at least 50 weight percent of the polymeric dispersant, based on the total weight of the polymeric dispersant; (ii) and an average of at least two amine groups per molecule, wherein the at least two amine groups are not present in the at least two polyether pendant groups; (b) the functionalized acid component comprises sulfonic acid and/or phosphoric acid functionalized with at least one of an aromatic functional group or a fatty functional group; (c) at least 60 percent of the amine groups present in the polymeric dispersant are each individually neutralized with a molecule of the functionalized acid component; and (d) the optional step of milling the pigment: (i) is not performed; (ii) is performed on the pigment alone prior to addition of the polymeric dispersant and/or the functionalized acid component; or (iii) is performed on a combination of the pigment and the polymeric dispersant and/or the functionalized acid component.
37. The method of embodiment 36, wherein the polymeric dispersant and the functionalized acid component are combined prior to addition of the pigment, wherein the optional step of milling the pigment is performed before or after the pigment is added to the combination of the polymeric dispersant and the functionalized acid component.
38. The method of embodiment 36, wherein the polymeric dispersant and the pigment are combined, the optional step of milling the pigment is performed on the combination of the polymeric dispersant and the pigment, and then the functionalized acid component is added to the pigment composition.
39. The method of any one of embodiments 36 to 38, wherein the polymeric dispersant comprises an average of from 2 to 200 polyether pendant groups per molecule.
40. The method of any one of embodiments 36 to 39, wherein from 50% to substantially all of the monomeric units of the polyether pendant groups are poly(ethylene oxide) monomeric units and/or poly(propylene oxide) monomeric units.
41. The method of any one of embodiments 36 to 40, wherein the ratio of the number of poly(ethylene oxide) monomeric units to the number of poly(propylene oxide) monomeric units is from 0:100 to 90:10.
42. The method of any one of embodiments 36 to 41, wherein the polyether pendant groups make up at least 65 weight percent of the polymeric dispersant, based on the total weight of the polymeric dispersant.
43. The method of any one of embodiments 36 to 42, wherein the polymeric dispersant comprises an average of from 2 to 500 amine groups per molecule.
44. The method of any one of embodiments 36 to 43, wherein the functionalized acid component comprises sulfonic acid functionalized with at least one of an aromatic functional group or a fatty functional group.
45. The method of any one of embodiments 36 to 44, wherein the functionalized acid component comprises dodecyl benzene sulfonic acid.
46. The method of any one of embodiments 36 to 45, wherein the aromatic functional group is an optionally substituted C₆-C₁₀ aromatic group.
47. The method of any one of embodiments 36 to 46, wherein the fatty functional group is a linear or branched, saturated or unsaturated, C₈-C₂₂ hydrocarbon group.
48. The method of any one of embodiments 36 to 47, wherein the functionalized acid component comprises at least one compound according to the following general formula:

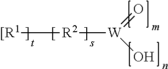

wherein: R¹ is a linear or branched, saturated or unsaturated, C₈-C₂₂ hydrocarbon group; R² is an aromatic functional group, optionally a substituted C₆-C₁₀ aromatic group; W is phosphorus or sulfur; m is 1 or 2, wherein m is 1 or 2 when W is sulfur, and m is 1 when W is phosphorus; n is 1 or 2, wherein n is 1 when W is sulfur, and n is 2 when W is phosphorus; s is 0 or 1; t is 0 or 1; with the proviso that s and t cannot both be 0.
49. The method of embodiment 48, wherein W is sulfur.
50. The method of either embodiment 48 or embodiment 49, wherein s is 1 and tis 1.
51. The method of any one of embodiments 36 to 50, wherein at least about 75 percent of the amine groups present in the polymeric dispersant are each individually neutralized with a molecule of the functionalized acid component.
52. The method of any one of embodiments 36 to 59, wherein at least about 95 percent of the amine groups present in the polymeric dispersant are each individually neutralized with a molecule of the functionalized acid component.
53. A method of manufacturing an ink formulation comprising, in order: (a) performing the method of any one of embodiment 36 to 52 to form a pigment dispersion; and (b) adding the following ingredients to the pigment dispersion: (i) a solvent; (ii) a binder; and (iii) at least one additional additive.
54. The method of embodiment 53, wherein the solvent is a polar solvent.
55. The method of either embodiment 53 or embodiment 54, wherein the binder is a polymeric binder.
56. The method of any one of embodiments 53 to 55, wherein at least one additional additive comprises from 1 to 5 additional additives.
57. The method of any one of embodiments 53 to 56, wherein the at least one additional additive comprises at least one of a wetting agent, a stabilizing agent, an adhesion promoter, a wax, or a defoamer.

Various features and embodiments of the present subject matter will be described below by way of non-limiting illustration.

As used herein, the indefinite article “a”/“an” is intended to mean one or more than one. As used herein, the phrase “at least one” means one or more than one of the following terms. Thus, “a”/“an” and “at least one” may be used interchangeably. For example “at least one of A, B or C” means that just one of A, B or C may be included, and any mixture of two or more of A, B and C may be included, in alternative embodiments.

As used herein, the term “substantially” means that a value of a given quantity is within +10% of the stated value. In other embodiments, the value is within +5% of the stated value. In other embodiments, the value is within +2.5% of the stated value. In other embodiments, the value is within +1% of the stated value.

As used herein, the term “substantially free of” means that a component does not include any intentional addition of the material which the component is “substantially free of”. For example, the component may include a material which the component is “substantially free of” at no more than impurity levels, which may be the result of incomplete chemical reactions and/or unintended/undesired (but perhaps unavoidable) reaction products.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional unrecited elements or steps that do not materially affect the essential or basic and novel characteristics of the composition or method under consideration.

Provided are compositions comprising: (a) a polymeric dispersant comprising: (i) an average of at least two polyether pendant groups per molecule, wherein the at least two polyether pendant groups are made up of monomeric units, wherein at least half of the monomeric units are poly(ethylene oxide) monomeric units and/or poly(propylene oxide) monomeric units, and wherein the at least two polyether pendant groups make up at least 50 weight percent of the polymeric dispersant, based on the total weight of the polymeric dispersant; and (ii) an average of at least two amine groups per molecule, wherein the at least two amine groups are not present in the at least two polyether pendant groups; and (b) a functionalized acid component comprising sulfonic acid and/or phosphoric acid functionalized with at least one of an aromatic functional group or a fatty functional group; and wherein at least 60 percent of the amine groups present in the polymeric dispersant are each individually neutralized with a molecule of the functionalized acid component. When describing herein an acid component functionalized with at least one of an aromatic functional group or a fatty functional group, what is meant is that the acid component is functionalized with either the aromatic functional group or the fatty functional group, and optionally either of these functional groups is further functionalized by a functional group of the other type. For example, the acid component may be functionalized with an aromatic functional group, and optionally the aromatic functional group may be further functionalized by a fatty functional group, or vice versa.

As used herein, the term “polyether pendant group(s)” refers to polyether groups which are attached to the backbone of the polymeric dispersant. In certain embodiments, the polyether pendant group(s) may be created by joining multiple alkylene oxide monomeric units (such as ethylene oxide and/or propylene oxide monomeric units), perhaps in combination with other monomeric units, together via known methods to form the polyether group, then attaching the polyether group to the backbone via known methods. This method of creating a polymeric dispersant provides the simplest conceptual understanding of what is meant by the terms “polyether pendant group(s)” and “backbone”.

In certain embodiments, it is possible to “grow” the polyether pendant group(s) off of the backbone of the polymeric dispersant by adding an alkylene oxide monomeric unit (such as ethylene oxide and/or propylene oxide monomeric units) to the backbone, then successively adding additional alkylene oxide monomeric units (such as ethylene oxide and/or propylene oxide monomeric units) to the first to create the pendant group(s). (This method may result in the same or a very similar polymeric dispersant as that which is created in the method described in the previous paragraph.) In this context, the term “polyether pendant group(s)” would be understood as meaning the portion of the polymeric dispersant which begins with the first alkylene oxide monomeric unit attached to the backbone, and continuing through the additional alkylene oxide monomeric units attached to the first. The “backbone” would then be considered to be those portions of the polymeric dispersant which are not polyether pendant group(s).

In the case of either of the method(s) described in the previous two paragraphs, the polyether pendant group(s) will be terminated with a monomeric unit which will remain relatively unreactive as compared to the monomeric units which make up the bulk of the polyether pendant group(s), as is well known in the art. In certain embodiments, substantially all of the monomeric units of the polyether pendant group(s) may be alkylene oxide monomeric units (such as ethylene oxide and/or propylene oxide monomeric units). By “substantially all”, what is meant is: (i) all of the monomeric units of the polyether pendant group(s) other than the terminating monomeric unit are alkylene oxide monomeric units; and/or (ii) a small number of monomeric units may be other than alkylene oxide monomeric units because of unintentional impurities in the monomeric units used to create the polyether pendant group(s).

As used herein, the terms “poly(alkylene oxide) monomeric units” and “alkylene oxide monomeric units” are used interchangeably. Similarly, the terms “poly(ethylene oxide) monomeric units” and “ethylene oxide monomeric units” are used interchangeably, and the terms “poly(propylene oxide) monomeric units” and “propylene oxide monomeric units” are used interchangeably. All of these terms refer to individual monomeric units which are joined together (directly or indirectly) to form the polyether pendant group(s) described herein.

In certain embodiments, the polymeric dispersant comprises an average of from 2 (such as 3, 4, 5, 6, 7, 8, 9, 10, 12, 14, 16, 18, 20, 25, 30, 35, 40, 45, 50, or 55) to 200 (such as 190, 180, 170, 160, 150, 140, 130, 120, 110, 100, 95, 90, 85, 80, 75, 70, 65, or 60) polyether pendant groups per molecule. In certain embodiments, the polymeric dispersant comprises an average of from 2 (such as 3, 4, 5, 6, 7, 8, 9, 10, 12, 14, 16, 18, 20, 25, 30, 35, 40, 45, 50, 55, 60, 65, 70, 75, 80, 85, 90, 95, or 100) to 200 (such as 190, 180, 170, 160, 150, 140, 130, 120, or 110) polyether pendant groups per molecule.

In certain embodiments, from 50% to substantially all of the monomeric units of the polyether pendant groups are poly(ethylene oxide) monomeric units and/or poly(propylene oxide) monomeric units. In certain embodiments, substantially all of the monomeric units of the polyether pendant groups are poly(ethylene oxide) monomeric units and/or poly(propylene oxide) monomeric units. In certain embodiments, from 50% (such as 55%, 60%, 65%, 70%, 75%, 80%, 85%, 90%, or 95%) to 99% of the monomeric units of the polyether pendant groups are poly(ethylene oxide) monomeric units and/or poly(propylene oxide) monomeric units. In certain embodiments, from 50% (such as 55%, 60%, 65%, 70%, 75%, 80%, 85%, or 90%) to 95% of the monomeric units of the polyether pendant groups are poly(ethylene oxide) monomeric units and/or poly(propylene oxide) monomeric units. In certain embodiments, from 50% (such as 55%, 60%, 65%, 70%, 75%, 80%, or 85%) to 90% of the monomeric units of the polyether pendant groups are poly(ethylene oxide) monomeric units and/or poly(propylene oxide) monomeric units. In certain embodiments, from 50% (such as 55%, 60%, 65%, 70%, 75%, or 80%) to 85% of the monomeric units of the polyether pendant groups are poly(ethylene oxide) monomeric units and/or poly(propylene oxide) monomeric units. In certain embodiments, from 50% (such as 55%, 60%, 65%, 70%, or 75%) to 80% of the monomeric units of the polyether pendant groups are poly(ethylene oxide) monomeric units and/or poly(propylene oxide) monomeric units. In certain embodiments, from 50% (such as 55%, 60%, 65%, or 70%) to 75% of the monomeric units of the polyether pendant groups are poly(ethylene oxide) monomeric units and/or poly(propylene oxide) monomeric units. In certain embodiments, from 50% (such as 55%, 60%, or 65%) to 70% of the monomeric units of the polyether pendant groups are poly(ethylene oxide) monomeric units and/or poly(propylene oxide) monomeric units. In certain embodiments, from 50% (such as 55%, or 60%) to 65% of the monomeric units of the polyether pendant groups are poly(ethylene oxide) monomeric units and/or poly(propylene oxide) monomeric units. In certain embodiments, from 50% (such as 55%) to 60% of the monomeric units of the polyether pendant groups are poly(ethylene oxide) monomeric units and/or poly(propylene oxide) monomeric units. In certain embodiments, from 50% to 55% of the monomeric units of the polyether pendant groups are poly(ethylene oxide) monomeric units and/or poly(propylene oxide) monomeric units.

In certain embodiments, the ratio of the number of poly(ethylene oxide) monomeric units to the number of poly(propylene oxide) monomeric units is from 0:100 (such as 10:90 or 20:80) to 100:0 (such as 90:10, 80:20, 70:30, 60:40, 50:50, 40:60, or 30:70). In certain embodiments, the ratio of the number of poly(ethylene oxide) monomeric units to the number of poly(propylene oxide) monomeric units is 0:100, 10:90, 17:83, 20:80, 30:70, 40:60, 50:50, 60:40, 70:30, 80:20, 90:10, or 100:0.

In certain embodiments, the polyether pendant groups make up at least 65 (such as 70, 75, 80, 85, 90, or 95) weight percent of the polymeric dispersant, based on the total weight of the polymeric dispersant. In certain embodiments, the polyether pendant groups make up from 65 (such as 70, 75, 80, 85, or 90) to 95 weight percent of the polymeric dispersant, based on the total weight of the polymeric dispersant. In certain embodiments, the polyether pendant groups make up from 65 (such as 70, 75, 80, or 85) to 90 weight percent of the polymeric dispersant, based on the total weight of the polymeric dispersant. In certain embodiments, the polyether pendant groups make up from 65 (such as 70, 75, or 80) to 85 weight percent of the polymeric dispersant, based on the total weight of the polymeric dispersant. In certain embodiments, the polyether pendant groups make up from 65 (such as 70, or 75) to 80 weight percent of the polymeric dispersant, based on the total weight of the polymeric dispersant. In certain embodiments, the polyether pendant groups make up from 65 (such as 70) to 75 weight percent of the polymeric dispersant, based on the total weight of the polymeric dispersant. In certain embodiments, the polyether pendant groups make up from 65 to 70 weight percent of the polymeric dispersant, based on the total weight of the polymeric dispersant. In certain embodiments, the polyether pendant groups make up 65 (such as 70, 75, 80, 85, 90, or 95) weight percent of the polymeric dispersant, based on the total weight of the polymeric dispersant.

In certain embodiments, the polymeric dispersant comprises an average of from 2 (such as 3, 4, 5, 6, 7, 8, 9, 10, 12, 14, 16, 18, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, or 240) to 500 (such as 490, 480, 470, 460, 450, 440, 430, 420, 410, 400, 390, 380, 370, 360, 350, 340, 330, 320, 310, 300, 290, 280, 270, 260, or 250) amine groups per molecule. In certain embodiments, the polymeric dispersant comprises an average of from 2 (such as 3, 4, 5, 6, 7, 8, 9, 10, 12, 14, 16, 18, 20, 25, 30, 35, 40, 45, 50, 55, 60, 65, 70, 75, 80, 85, 90, 95, 100, 110, 120, 130, 140, 150, 160, 170, 180, or 190) to 500 (such as 490, 480, 470, 460, 450, 440, 430, 420, 410, 400, 390, 380, 370, 360, 350, 340, 330, 320, 310, 300, 290, 280, 270, 260, 250, 240, 230, 220, 210, or 200) amine groups per molecule. In certain embodiments, the polymeric dispersant comprises an average of from 2 (such as 3, 4, 5, 6, 7, 8, 9, 10, 12, 14, 16, 18, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, or 290) to 500 (such as 490, 480, 470, 460, 450, 440, 430, 420, 410, 400, 390, 380, 370, 360, 350, 340, 330, 320, 310, or 300) amine groups per molecule.

In certain embodiments, the functionalized acid component comprises sulfonic acid functionalized with at least one of an aromatic functional group or a fatty functional group.

In certain embodiments, the functionalized acid component comprises dodecyl benzene sulfonic acid. An illustrative commercially-available dodecyl benzene sulfonic acid is Maranil® DBS/LC, available from BASF.

In certain embodiments, the aromatic functional group is an optionally substituted C₆-C₁₀ aromatic group. In certain embodiments, the aromatic functional group is a C₆-C₁₀ aromatic group. In certain embodiments, the aromatic functional group is a substituted C₆-C₁₀ aromatic group. In certain embodiments, the aromatic functional group is an optionally substituted C₈-C₁₀ aromatic group. In certain embodiments, the aromatic functional group is a C₈-C₁₀ aromatic group. In certain embodiments, the aromatic functional group is a substituted C₈-C₁₀ aromatic group. In certain embodiments, the aromatic functional group is an optionally substituted C₆-C₈ aromatic group. In certain embodiments, the aromatic functional group is a C₆-C₈ aromatic group. In certain embodiments, the aromatic functional group is a substituted C₆-C₈ aromatic group. In certain embodiments, the aromatic functional group is an optionally substituted C₆ aromatic group. In certain embodiments, the aromatic functional group is a C₆ aromatic group. In certain embodiments, the aromatic functional group is a substituted C₆ aromatic group. In certain embodiments, the aromatic functional group is an optionally substituted C₈ aromatic group. In certain embodiments, the aromatic functional group is a C₈ aromatic group. In certain embodiments, the aromatic functional group is a substituted C₈ aromatic group. In certain embodiments, the aromatic functional group is an optionally substituted C₁₀ aromatic group. In certain embodiments, the aromatic functional group is a C₁₀ aromatic group. In certain embodiments, the aromatic functional group is a substituted C₁₀ aromatic group.

In certain embodiments, the fatty functional group is a linear or branched, saturated or unsaturated, C₈-C₂₂ hydrocarbon group. In certain embodiments, the fatty functional group is a linear or branched, saturated or unsaturated, C₈-C₂₀ hydrocarbon group. In certain embodiments, the fatty functional group is a linear or branched, saturated or unsaturated, C₈-C₁₈ hydrocarbon group. In certain embodiments, the fatty functional group is a linear or branched, saturated or unsaturated, C₈-C₁₆ hydrocarbon group. In certain embodiments, the fatty functional group is a linear or branched, saturated or unsaturated, C₈-C₁₄ hydrocarbon group. In certain embodiments, the fatty functional group is a linear or branched, saturated or unsaturated, C₈-C₁₂ hydrocarbon group. In certain embodiments, the fatty functional group is a linear or branched, saturated or unsaturated, C₈-C₁₀ hydrocarbon group. In certain embodiments, the fatty functional group is a linear or branched, saturated or unsaturated, C₈ hydrocarbon group. In certain embodiments, the fatty functional group is a linear or branched, saturated or unsaturated, C₁₀-C₂₂ hydrocarbon group. In certain embodiments, the fatty functional group is a linear or branched, saturated or unsaturated, C₁₀-C₂₀ hydrocarbon group. In certain embodiments, the fatty functional group is a linear or branched, saturated or unsaturated, C₁₀-C₁₈ hydrocarbon group. In certain embodiments, the fatty functional group is a linear or branched, saturated or unsaturated, C₁₀-C₁₆ hydrocarbon group. In certain embodiments, the fatty functional group is a linear or branched, saturated or unsaturated, C₁₀-C₁₄ hydrocarbon group. In certain embodiments, the fatty functional group is a linear or branched, saturated or unsaturated, C₁₀-C₁₂ hydrocarbon group. In certain embodiments, the fatty functional group is a linear or branched, saturated or unsaturated, C₁₀ hydrocarbon group. In certain embodiments, the fatty functional group is a linear or branched, saturated or unsaturated, C₁₂-C₂₂ hydrocarbon group. In certain embodiments, the fatty functional group is a linear or branched, saturated or unsaturated, C₁₂-C₂₀ hydrocarbon group. In certain embodiments, the fatty functional group is a linear or branched, saturated or unsaturated, C₁₂-C₁₈ hydrocarbon group. In certain embodiments, the fatty functional group is a linear or branched, saturated or unsaturated, C₁₂-C₁₆ hydrocarbon group. In certain embodiments, the fatty functional group is a linear or branched, saturated or unsaturated, C₁₂-C₁₄ hydrocarbon group. In certain embodiments, the fatty functional group is a linear or branched, saturated or unsaturated, C₁₂ hydrocarbon group. In certain embodiments, the fatty functional group is a linear or branched, saturated or unsaturated, C₁₄-C₂₂ hydrocarbon group. In certain embodiments, the fatty functional group is a linear or branched, saturated or unsaturated, C₁₄-C₂₀ hydrocarbon group. In certain embodiments, the fatty functional group is a linear or branched, saturated or unsaturated, C₁₄-C₁₈ hydrocarbon group. In certain embodiments, the fatty functional group is a linear or branched, saturated or unsaturated, C₁₄-C₁₆ hydrocarbon group. In certain embodiments, the fatty functional group is a linear or branched, saturated or unsaturated, C₁₄ hydrocarbon group. In certain embodiments, the fatty functional group is a linear or branched, saturated or unsaturated, C₁₆-C₂₂ hydrocarbon group. In certain embodiments, the fatty functional group is a linear or branched, saturated or unsaturated, C₁₆-C₂₀ hydrocarbon group. In certain embodiments, the fatty functional group is a linear or branched, saturated or unsaturated, C₁₆-C₁₈ hydrocarbon group. In certain embodiments, the fatty functional group is a linear or branched, saturated or unsaturated, C₁₆ hydrocarbon group. In certain embodiments, the fatty functional group is a linear or branched, saturated or unsaturated, C₁₈-C₂₂ hydrocarbon group. In certain embodiments, the fatty functional group is a linear or branched, saturated or unsaturated, C₁₈-C₂₀ hydrocarbon group. In certain embodiments, the fatty functional group is a linear or branched, saturated or unsaturated, C₁₈ hydrocarbon group. In certain embodiments, the fatty functional group is a linear or branched, saturated or unsaturated, C₂₀-C₂₂ hydrocarbon group. In certain embodiments, the fatty functional group is a linear or branched, saturated or unsaturated, C₂₀ hydrocarbon group. In certain embodiments, the fatty functional group is a linear or branched, saturated or unsaturated, C₂₂ hydrocarbon group.

In certain embodiments, the functionalized acid component comprises at least one compound according to the following general formula:

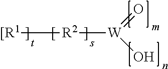

wherein:
R¹ is a linear or branched, saturated or unsaturated, C₈-C₂₂ hydrocarbon group (in alternative embodiments, R¹ may be a hydrocarbon group of one of the various embodiments described above);
R² is an aromatic functional group, optionally a substituted C₆-C₁₀ aromatic group (in alternative embodiments, R² may be an aromatic group of one of the various embodiments described above);
W is phosphorus or sulfur;
m is 1 or 2, wherein m is 1 or 2 when W is sulfur, and m is 1 when W is phosphorus;
n is 1 or 2, wherein n is 1 when W is sulfur, and n is 2 when W is phosphorus;
s is 0 or 1;
t is 0 or 1;
with the proviso that s and t cannot both be 0.

In certain embodiments, W is sulfur. In certain embodiments, W is phosphorus. In certain embodiments, W is sulfur, m is 1, and n is 1. In certain embodiments, W is sulfur, m is 2 and n is 1. In certain embodiments, W is phosphorus, m is 1 and n is 2.

In certain embodiments, s is 1 and tis 1. In certain embodiments, s is 0 and tis 1. In certain embodiments, s is 1 and t is 0.

In certain embodiments, at least 60 (such as 65, 70, 75, 80, 85, 90, or 95) percent of the amine groups present in the polymeric dispersant are each individually neutralized with a molecule of the functionalized acid component. In certain embodiments, substantially all of the amine groups present in the polymeric dispersant are each individually neutralized with a molecule of the functionalized acid component. In this context, “substantially all” means that the number of amine groups neutralized with a molecule of the functionalized acid component is as high as physically/chemically possible in the circumstances.

As present in the polymeric dispersant, each amine group may independently be primary, secondary, or tertiary. In certain embodiments, it may be undesirable for the amine group to be present within a polyether pendant group, as it may cause the polyether pendant group to prefer to associate with the pigment surface rather than solvate in the liquid medium, or otherwise render the polyether pendant group unsuitable for its purpose of dispersing a pigment (affiliated with the amine group(s) of the backbone) into a liquid medium.

Suitable polymeric dispersants according to the present subject matter are disclosed, for example, in U.S. Pat. No. 7,767,750 B2, U.S. Pat. No. 8,859,675 B2, U.S. Pat. No. 8,987,374 B2, and U.S. Pat. No. 9,416,280 B2. It is noted that these documents may disclose polymeric dispersants which are outside the scope of the broadest embodiments of the present subject matter; with that caveat, these documents disclose many embodiments of suitable polymeric dispersants which fall within the scope of the present subject matter, and are therefore illustrative of the polymeric dispersants described herein.

In certain embodiments, the composition(s) described above does not include materials which would interfere with the neutralization of the amine groups with the functionalized acid component. In certain embodiments, materials which may interfere with the neutralization of the amine groups with the functionalized acid component are not added to the composition(s) described herein until after the desired amount of neutralization has occurred.

Also provided are pigment dispersions comprising: (a) a pigment; (b) a polymeric dispersant for the pigment comprising: (i) an average of at least two polyether pendant groups per molecule, wherein the at least two polyether pendant groups are made up of monomeric units, wherein at least half of the monomeric units are poly(ethylene oxide) monomeric units and/or poly(propylene oxide) monomeric units, and wherein the at least two polyether pendant groups make up at least 50 weight percent of the polymeric dispersant, based on the total weight of the polymeric dispersant; and (ii) an average of at least two amine groups per molecule, wherein the at least two amine groups are not present in the at least two polyether pendant groups; and (c) a functionalized acid component comprising sulfonic acid and/or phosphoric acid functionalized with at least one of an aromatic functional group or a fatty functional group; and wherein at least 60 percent of the amine groups present in the polymeric dispersant are each individually neutralized with a molecule of the functionalized acid component. In certain embodiments, the pigment dispersion(s) comprise: (a) a pigment; and (b) any one of the compositions described hereinabove.

Further provided are ink formulations comprising: (a) the pigment dispersion(s) described hereinabove; (b) a solvent; (c) a binder; and (d) at least one additional additive.

In certain embodiments, the solvent is a polar solvent.

In certain embodiments, the binder is a polymeric binder.

In certain embodiments, the at least one additional additive comprises from 1 to 5 additional additives.

In certain embodiments, the at least one additional additive comprises at least one of a wetting agent, a stabilizing agent, an adhesion promoter, a wax, or a defoamer.

In certain embodiments, materials which may interfere with the neutralization of the amine groups with the functionalized acid component are not added to the ink formulation(s) described herein until after the desired amount of neutralization has occurred.

Also provided are methods of producing a pigment dispersion comprising a step of combining, in any order, a pigment, a polymeric dispersant for the pigment, and a functionalized acid component, and an optional step of milling the pigment, wherein: (a) the polymeric dispersant comprises: (i) an average of at least two polyether pendant groups per molecule, wherein the at least two polyether pendant groups are made up of monomeric units, wherein at least half of the monomeric units are poly(ethylene oxide) monomeric units and/or poly(propylene oxide) monomeric units, and wherein the at least two polyether pendant groups make up at least 50 weight percent of the polymeric dispersant, based on the total weight of the polymeric dispersant; (ii) and an average of at least two amine groups per molecule, wherein the at least two amine groups are not present in the at least two polyether pendant groups; (b) the functionalized acid component comprises sulfonic acid and/or phosphoric acid functionalized with at least one of an aromatic functional group or a fatty functional group; (c) at least 60 percent of the amine groups present in the polymeric dispersant are each individually neutralized with a molecule of the functionalized acid component; and (d) the optional step of milling the pigment: (i) is not performed; (ii) is performed on the pigment alone prior to addition of the polymeric dispersant and/or the functionalized acid component; or (iii) is performed on a combination of the pigment and the polymeric dispersant and/or the functionalized acid component.

In certain embodiments, the polymeric dispersant and the functionalized acid component are combined prior to addition of the pigment, wherein the optional step of milling the pigment is performed before or after the pigment is added to the combination of the polymeric dispersant and the functionalized acid component. In certain embodiments, the polymeric dispersant and the functionalized acid component are combined prior to addition of the pigment, wherein the step of milling the pigment is performed before or after the pigment is added to the combination of the polymeric dispersant and the functionalized acid component. In certain embodiments, the polymeric dispersant and the functionalized acid component are combined prior to addition of the pigment, wherein the step of milling the pigment is performed before the pigment is added to the combination of the polymeric dispersant and the functionalized acid component. In certain embodiments, the polymeric dispersant and the functionalized acid component are combined prior to addition of the pigment, wherein the step of milling the pigment is performed after the pigment is added to the combination of the polymeric dispersant and the functionalized acid component.

In certain embodiments, the polymeric dispersant and the pigment are combined, the optional step of milling the pigment is performed on the combination of the polymeric dispersant and the pigment, and then the functionalized acid component is added to the pigment composition. In certain embodiments, the polymeric dispersant and the pigment are combined, the step of milling the pigment is performed on the combination of the polymeric dispersant and the pigment, and then the functionalized acid component is added to the pigment composition.

In certain embodiments, the polymeric dispersant for the pigment and the functionalized acid component may together be made up of any one of the compositions described hereinabove.

Further provided are methods of manufacturing an ink formulation comprising, in order: (a) performing the method(s) of producing a pigment dispersion described above to form a pigment dispersion; and (b) adding the following ingredients to the pigment dispersion: (i) a solvent; (ii) a binder; and (iii) at least one additional additive.

In certain embodiments, the solvent is a polar solvent.

In certain embodiments, the binder is a polymeric binder.

In certain embodiments, the at least one additional additive comprises from 1 to 5 additional additives.

In certain embodiments, the at least one additional additive comprises at least one of a wetting agent, a stabilizing agent, an adhesion promoter, a wax, or a defoamer.

In certain embodiments of the method(s) described above, materials which may interfere with the neutralization of the amine groups with the functionalized acid component are not added to the ink formulation(s) described herein until after the desired amount of neutralization has occurred. Such materials may include resins, binders, and/or additional additives, as would be apparent to a person of ordinary skill in the art.

The subject matter disclosed herein may be better understood with reference to the following examples, which are set forth merely to further illustrate the subject matter disclosed herein. The illustrative examples should not be construed as limiting the subject matter in any manner.

Comparative Example 1: Example 1 from U.S. Pat. No. 7,767,750 B2, issued Aug. 3, 2010 to inventor Dean Thetford and assignee The Lubrizol Corporation, column 11, lines 35-57.

Comparative Example 2: Intermediate A was made by charging 200 parts SURFONAMINE® B-200 polyetheramine (from Huntsman International LLC) to a reaction vessel with 11.6 parts 2-hydroxyethyl acrylate and 0.03 parts 2,6-di-tertbutyl-4-methyl phenol, followed by stirring for 48 hours at 70° C. 250 parts ethyl acetate and 67.6 parts tolylene-2,4-diisocyanate were charged to a separate reaction vessel under nitrogen, followed by agitation and charging 289.7 parts of Intermediate A and 125 parts ethyl acetate over 10 minutes. Then 15.78 parts 1,1′-((3-(dimethylamino)propyl)imino)bis(2-propanol) and 32.55 parts ethyl acetate were charged to the vessel over 10 minutes. Then the mixture was heated to 65° C. for one hour, followed by charging 95.13 parts SURFONAMINE® B-200 polyetheramine and 94.7 parts ethyl acetate, followed by stirring at 65° C. for an additional two hours to yield the dispersant of Comparative Example 2.

Comparative Example 3: A dispersant was produced according to the process described in Example 7 from U.S. Pat. No. 9,416,280 B2, issued Aug. 16, 2016 to inventor Stuart N. Richards and Assignee Lubrizol Limited, column 11, lines 45-53 (with reference to Comparative Example C at column 10, lines 25-48), using 24 parts EF60, 50 parts Jeffamine M2005 and 0.93 parts DMAPA in ethyl acetate. The resulting mixture was adjusted to 40.0 weight percent solids by addition of extra ethyl acetate.

Comparative Example 4: A dispersant was produced by adding 0.25 parts acetic acid to 1.75 parts of Comparative Example 1, followed by mechanical stirring for about 1 minute until the material appeared homogenous, after which the vessel was placed on a set of rollers to provide gentle mixing for about 30 minutes.

Comparative Example 5: A dispersant was produced by adding 0.13 parts benzoic acid to 1.87 parts of Comparative Example 1, followed by mechanical stirring for about 1 minute until the material appeared homogenous, after which the vessel was placed on a set of rollers to provide gentle mixing for about 30 minutes.

Example 1: A mixture of 225 parts of Comparative Example 1 and 309.38 parts ethanol was stirred at 50° C. for 1 hour, followed by adding 84.38 parts dodecylbenzenesulfonic acid and stirring for an additional hour at 50° C., to create a dispersant.

Example 2: A mixture of 6.15 parts of Comparative Example 2 and 22.48 parts ethanol was mechanically stirred for about 1 minute until the material appeared homogenous, after which the vessel was placed on a set of rollers to provide gentle mixing for about 30 minutes. Then, 0.47 parts dodecylbenzenesulfonic acid was added to the mixture, followed by mechanical stirring for about 1 minute until the material appeared homogenous, after which the vessel was placed on a set of rollers to provide gentle mixing for about 30 minutes, to create a dispersant.

Example 3: A mixture of 7.14 parts of Comparative Example 3, 19.52 parts ethanol, and 2.17 parts ethyl acetate, was mechanically stirred for about 1 minute until the material appeared homogenous, after which the vessel was placed on a set of rollers to provide gentle mixing for about 30 minutes. Then, 0.47 parts dodecylbenzenesulfonic acid was added to the mixture, followed by mechanical stirring for about 1 minute until the material appeared homogenous, after which the vessel was placed on a set of rollers to provide gentle mixing for about 30 minutes, to create a dispersant.

Example 4: 35 parts of Comparative Example 3 were charged to a reaction flask and stirred under nitrogen, 0.21 parts of Benzenesulfonic acid were charged to the reaction vessel along with 0.21 parts of ethyl acetate, the reaction mixture was then heated to 50° C. for 1 hour with a conder fitted to the flask, to create a dispersant.

Example 5: 35 parts of Comparative Example 3 were charged to a reaction flask and stirred under nitrogen, 0.21 parts of Phenylphosphonic acid were charged to the reaction vessel along with 0.21 parts of ethyl acetate, the reaction mixture was then heated to 50° C. for 1 hour with a conder fitted to the flask, to create a dispersant.

To determine whether a particular dispersant may be suitable for use in an ink (such as an ink used in printing packaging materials), two types of experiments may be conducted: a Compatibility Test and one or both of Dispersion Test A and Dispersion Test B, as described below. A particular dispersant may be deemed suitable for use in a (packaging) ink if it passes the Compatibility Test and at least one of Dispersion Test A or Dispersion Test B.

Each of the dispersants described in the Examples and Comparative Examples above were tested according to the Compatibility Test and one of Dispersion Test A or Dispersion Test B, with the results reported in Table 1, below. The Compatibility Test is a measure of whether a dispersant is compatible with the ink medium. Dispersion Test A and Dispersion Test B are methods of determining whether a dispersant is capable of dispersing a particular pigment, and each test may be representative of whether other similar pigments may pass the same test, and may thus indicate that a dispersant is suitable for use with other similar pigments. Therefore, passing the Compatibility Test and at least one of Dispersion Test A or Dispersion Test B will indicate that a particular dispersant is suitable for use with at least one type of pigment.

Compatibility Test (“CT”): Four parts of a nitrocellulose varnish (DLX 3-5 from Nobel NC Co., Ltd.) was dissolved in five parts ethanol and one part ethyl acetate to make the varnish solution. Separately, two parts of the dispersant were dissolved in three parts of an ethanol solvent. Five parts of the varnish solution was added to the mixture and stirred, followed by addition of two parts of an organic titanate (TYZOR® IAM from Dorf Ketal Chemicals India Pvt Ltd) and stirring until homogenous. After a two-week storage period at room temperature, the mixture was observed, and any gel formation and/or turbidity was noted as a failure of the Compatibility Test, while a flowable clear fluid was noted as a pass of the Compatibility Test.

Dispersion Test B (“DTB”): 3.39 parts of the dispersant was dissolved in 22.48 parts ethanol and 3.39 parts ethyl acetate. 15.75 parts of pigment Blue 15:4 were added and stirred to wet-out the pigment. 125 parts of 3 mm glass beads were added, and the resulting mixture was dispersed using a DAS 200 disperser (available from LAU GmbH) for one hour to produce a millbase. The viscosity of the millbase was measured using a TA rheometer using a parallel plate setup at 25° C. with a 250 μm gap. A viscosity value equivalent to or above 2 Pa·s at a shear rate of 38 s⁻¹ was considered a failure of Dispersion Test B, while a value below 2 Pa·s at a shear rate of 38 s⁻¹ was considered a pass of Dispersion Test B.

TABLE 1

| | | | | Over- |
|---|---|---|---|---|
| | CT | DTA | DTB | all |
| Comp. Ex. 1 | Gelled - Fail | 0.26 Pa · s - Pass | | Fail |
| Example 1 | Fluid - Pass | 0.99 Pa · s - Pass | | Pass |
| Comp. Ex. 2 | Gelled - Fail | | 0.08 Pa · s - Pass | Fail |
| Example 2 | Fluid - Pass | | 0.39 Pa · s - Pass | Pass |
| Comp. Ex. 3 | Gelled - Fail | | 0.07 Pa · s - Pass | Fail |
| Example 3 | Fluid - Pass | | 1.06 Pa · s - Pass | Pass |
| Comp. Ex. 4 | Gelled - Fail | 2.09 Pa · s - Fail | | Fail |
| Comp. Ex. 5 | Gelled - Fail | 2.77 Pa · s - Fail | | Fail |
| Example 4 | Fluid - Pass | | 0.65 Pa · s - Pass | Pass |
| Example 5 | Fluid - Pass | | 0.22 Pa · s - Pass | Pass |

Except in the Examples, or where otherwise explicitly indicated or required by context, all numerical quantities in this description specifying amounts of materials, reaction conditions, molecular weights, number of carbon atoms, and the like, are to be understood as modified by the word “about”. As used herein, the term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value. In other embodiments, the value is within a range of the explicitly-described value which would be understood by those of ordinary skill, based on the disclosures provided herein, to perform substantially similarly to compositions including the literal amounts described herein.

It is to be understood that the upper and lower amount, range, and ratio limits set forth herein may be independently combined, and that any amount within a disclosed range is contemplated to provide a minimum or maximum of a narrower range in alternative embodiments (with the proviso, of course, that the minimum amount of a range must be lower than the maximum amount of the same range). Similarly, the ranges and amounts for each element of the subject matter disclosed herein may be used together with ranges or amounts for any of the other elements.

While certain representative embodiments and details have been shown for the purpose of illustrating the subject matter disclosed herein, it will be apparent to those skilled in this art that various changes and modifications may be made therein without departing from the scope of the subject matter. In this regard, the scope of the invention is to be limited only by the following claims.

1. A composition comprising:
a. a polymeric dispersant comprising:
i. an average of at least two polyether pendant groups per molecule, wherein the at least two polyether pendant groups are made up of monomeric units, wherein at least half of the monomeric units are poly(ethylene oxide) monomeric units and/or poly(propylene oxide) monomeric units, and wherein the at least two polyether pendant groups make up at least 50 weight percent of the polymeric dispersant, based on the total weight of the polymeric dispersant; and
ii. an average of at least two amine groups per molecule, wherein the at least two amine groups are not present in the at least two polyether pendant groups; and
b. a functionalized acid component comprising sulfonic acid and/or phosphoric acid functionalized with at least one of an aromatic functional group or a fatty functional group; and
wherein at least 60 percent of the amine groups present in the polymeric dispersant are each individually neutralized with a molecule of the functionalized acid component.

2. The composition of claim 1, wherein the polymeric dispersant comprises an average of from 2 to 200 polyether pendant groups per molecule.

3. The composition of claim 1, wherein from 50% to substantially all of the monomeric units of the polyether pendant groups are poly(ethylene oxide) monomeric units and/or poly(propylene oxide) monomeric units.

4. The composition of claim 1, wherein the ratio of the number of poly(ethylene oxide) monomeric units to the number of poly(propylene oxide) monomeric units is from 0:100 to 90:10.

5. The composition of claim 1, wherein the polyether pendant groups make up at least 65 weight percent of the polymeric dispersant, based on the total weight of the polymeric dispersant.

6. The composition of claim 1, wherein the polymeric dispersant comprises an average of from 2 to 500 amine groups per molecule.

7. The composition of claim 1, wherein the functionalized acid component comprises sulfonic acid functionalized with at least one of an aromatic functional group or a fatty functional group.

8. The composition of claim 1, wherein the functionalized acid component comprises dodecyl benzene sulfonic acid.

9. The composition of claim 1, wherein the aromatic functional group is an optionally substituted C₆-C₁₀ aromatic group.

10. The composition of claim 1, wherein the fatty functional group is a linear or branched, saturated or unsaturated, C₈-C₂₂ hydrocarbon group.

11. The composition of claim 1, wherein the functionalized acid component comprises at least one compound according to the following general formula: 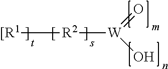
wherein:
R¹ is a linear or branched, saturated or unsaturated, C₈-C₂₂ hydrocarbon group;
R² is an aromatic functional group, optionally a substituted C₆-C₁₀ aromatic group;
W is phosphorus or sulfur;
m is 1 or 2, wherein m is 1 or 2 when W is sulfur, and m is 1 when W is phosphorus;
n is 1 or 2, wherein n is 1 when W is sulfur, and n is 2 when W is phosphorus;
s is 0 or 1;
t is 0 or 1;
with the proviso that s and t cannot both be 0.

12. The composition of claim 11, wherein W is sulfur.

13. The composition of claim 11, wherein s is 1 and tis 1.

14. The composition of claim 1, wherein at least about 75 percent of the amine groups present in the polymeric dispersant are each individually neutralized with a molecule of the functionalized acid component.

15. The composition of claim 1, wherein at least about 95 percent of the amine groups present in the polymeric dispersant are each individually neutralized with a molecule of the functionalized acid component.

16. A pigment dispersion comprising:
a. a pigment; and
b. a polymeric dispersant for the pigment, the polymeric dispersant comprising the composition of claim 1.

17. An ink formulation comprising:
a. the pigment dispersion of claim 16;
b. a solvent;
c. a binder; and
d. at least one additional additive.

18. A method of producing a pigment dispersion comprising a step of combining, in any order, a pigment, a polymeric dispersant for the pigment, and a functionalized acid component, and an optional step of milling the pigment, wherein:
a. the polymeric dispersant comprises:
i. an average of at least two polyether pendant groups per molecule, wherein the at least two polyether pendant groups are made up of monomeric units, wherein at least half of the monomeric units are poly(ethylene oxide) monomeric units and/or poly(propylene oxide) monomeric units, and wherein the at least two polyether pendant groups make up at least 50 weight percent of the polymeric dispersant, based on the total weight of the polymeric dispersant;
ii. and an average of at least two amine groups per molecule, wherein the at least two amine groups are not present in the at least two polyether pendant groups;
b. the functionalized acid component comprises sulfonic acid and/or phosphoric acid functionalized with at least one of an aromatic functional group or a fatty functional group;
c. at least 60 percent of the amine groups present in the polymeric dispersant are each individually neutralized with a molecule of the functionalized acid component; and
d. the optional step of milling the pigment:
i. is not performed;
ii. is performed on the pigment alone prior to addition of the polymeric dispersant and/or the functionalized acid component; or
iii. is performed on a combination of the pigment and the polymeric dispersant and/or the functionalized acid component.

19. The method of claim 18, wherein the polymeric dispersant and the functionalized acid component are combined prior to addition of the pigment, wherein the optional step of milling the pigment is performed before or after the pigment is added to the combination of the polymeric dispersant and the functionalized acid component.

20. The method of claim 18, wherein the polymeric dispersant and the pigment are combined, the optional step of milling the pigment is performed on the combination of the polymeric dispersant and the pigment, and then the functionalized acid component is added to the pigment composition.
